(19) United States
(12) Patent Application Publication
(10) Pub. No.: US 2007/0129873 A1
(43) Pub. Date: Jun. 7, 2007

(54) Method and apparatus for influencing a motor torque

(75) Inventor: Werner Bernzen, Ehningen (DE)

Correspondence Address: FITCH, EVEN, TABIN & FLANNERY, P. O. BOX 18415, WASHINGTON, DC, 20036, US

(73) Assignee: DaimlerChrysler AG, Stuttgart (DE)

(21) Appl. No.: 10/583,968

(22) PCT Filed: Nov. 27, 2004
(86) PCT No.: PCT/EP04/13482

§ 371 Date: Oct. 31, 2006

(30) Foreign Application Priority Data
Dec. 23, 2003 (DE) 103 60 727.7
Mar. 19, 2004 (DE) 10 2004 013 512.6

(51) Int. Cl. B60T 7/12

(52) U.S. Cl. 701/96; 701/78

(57) ABSTRACT

The invention relates to a method and an apparatus for influencing an actual engine torque delivered by an engine (6) that forms part of the drive means (7) of a vehicle. The invention relates to an auxiliary function for executing a creeping motion of a vehicle, even in the event of an uphill start operation or during uphill travel. To this end, the actual engine torque (Mᵢ) is determined during an uphill start operation or an uphill travel in accordance with a roadway inclination (Θ*) which represents a roadway inclination in the direction of travel and a brake pedal variable (s) which represents the deflection of a driver-actuated brake pedal (9) and which cooperates with braking means (30) of the vehicle.

The invention relates to a method and an apparatus for influencing an actual engine torque as defined in the preamble of claims 1 and 18, respectively. The invention relates to an auxiliary function for performing a creeping motion of a vehicle even in case of travel resistance caused by an upward inclined roadway in a travel direction selected by the driver. To this end, in case of an uphill-directed vehicle start or an uphill travel, the actual torque supplied by an engine driving the vehicle, is determined as a function of a roadway inclination variable representing the roadway inclination in the travel direction.

Printed publication DE 198 38 970 A1 discloses a method which determines a driving force tending to move the vehicle against its travel direction. The actual engine torque of the engine driving the vehicle is influenced as a function of the determined, above-noted rollback force in a driver-independent manner. It is the purpose of the method to simplify an uphill-directed start operation in case of an inclined roadway by setting the actual engine torque in such a start operation so that the rollback force acting on the vehicle against its travel direction is essentially compensated for and thus a rollback during the starting operation is prevented.

The known method has the drawback that the driver of the vehicle cannot interfere with the actual engine torque because of the influence thereon effected due to an inclined roadway.

It is therefore the object of the invention to provide a method and an apparatus of the earlier-noted type, by means of which the vehicle driver is capable of interfering with the actual engine torque which is influenced due to an inclined roadway.

This object is achieved according to the features defined in claims 1 and 18.

In an activated state of the auxiliary function, in case of an uphill-directed vehicle start operation or an uphill travel, the actual torque supplied by an engine which is part of the vehicle drive means, is determined as a function of a roadway inclination representing the roadway inclination in the travel direction. Further, the actual engine torque is determined as a function of a brake pedal variable representing a driver-effected deflection of a brake pedal cooperating with the braking means of the vehicle. Thus, the driver is, in a simple manner, capable of interfering with the actual engine torque influenced due to an inclined roadway in the travel direction.

Advantageous embodiments of the method according to the invention are contained in the dependent claims.

For an uphill directed stating operation or an uphill travel, the actual engine torque is advantageously influenced in such a manner that the vehicle assumes a low travel speed which is independent from the roadway inclination. Such a travel speed preferably has a magnitude which is typical for a creeping motion. In this manner the creeping motion of a vehicle customary for an even roadway or also for an inclined roadway may be obtained. A creeping motion occurs in a vehicle which has an automatic transmission, an automated gearbox or a transmission with an automatic clutch.

In a vehicle which is provided, on the one hand, with an automatic transmission or an automated gearbox or a transmission with an automatic clutch and, on the other hand, with an apparatus with which the method according to the invention is performed, a low travel speed typical for a creeping motion is obtained by the mere shifting into a travel stage or reverse travel stage, that is, by shifting into the first gear or the reverse gear. The thus-obtained low travel speed may be reduced to zero by the driver solely by actuating the brake pedal. By increasing a deflection of the brake pedal, on the one hand, there is an increase in the braking force which is generated in the wheel braking devices of the vehicle and which brakes the vehicle and, on the other hand, the actual engine torque delivered by the engine is influenced in such a manner that it decreases. The latter influencing action has mainly the purpose of avoiding an unnecessary fuel consumption. Such reduction may be particularly effected in a stepless manner. Thus, for example, the driver may park the vehicle or leave its parking space on an inclined roadway in a safe and comfortable manner exclusively by actuating the brake pedal.

The influencing of the actual engine torque may be effected in a simple manner by determining the magnitude of a nominal engine torque as a function of the roadway inclination and the brake pedal variable. In such a case the nominal engine torque serves as a previously determined magnitude, in accordance with which the actual engine torque is set.

The brake pedal variable expediently has a range defined by a lower limit and an upper limit, whereby for the brake pedal a deflection range is defined, within which the driver may adjust the brake pedal. To the lower limit the non-actuated condition of the brake pedal and to the upper limit the maximum possible deflection of the brake pedal are assigned. The nominal engine torque decreases toward the upper limit from a maximum magnitude at the lower limit. In this manner, for example, a low travel speed which is in a causal connection with magnitude of the nominal engine torque, decreases with an increasing deflection of the brake pedal as accustomed to by the driver. Further, the possibility is advantageously provided that for magnitudes of the brake pedal variable which correspond in magnitude to an intermediate value in a range defined by the lower limit and the upper limit, the nominal engine torque assumes a constant magnitude which is preferably zero.

The maximum nominal engine torque may be determined according to the equation M_{s,max}=M⁰_{s,max}+k.|Θ*|, wherein M⁰_{s,max} is the engine torque which is obtained by the idling regulator of the engine in an engaged travel stage on a roadway of no inclination. By the selection of the above function, the nominal engine torque, at least at the lower limit of the brake pedal variable, that is, when the brake pedal is not actuated, may compensate for a travel resistance caused by a roadway ascending in the driver-selected travel direction and represented by the roadway inclination Θ*. Further, k is a factorial function which, by appropriate selection, makes it possible that the vehicle, at least at the lower limit of the brake pedal variable and independently from the degree of roadway inclination, always assumes the same low travel speed at an uphill oriented starting operation or during uphill travel. Such low travel speed has a magnitude typical particularly for a creeping motion.

Apart from influencing the nominal engine torque as a function of the roadway inclination, the nominal engine torque may be additionally determined for a roadway which has substantially no inclination as well for an uphill oriented start operation or for uphill travel, as a function of a vehicle mass variable representing the mass of the vehicle and/or as a function of a rolling resistance variable characterizing the rolling resistance of the driven wheels traveling on the roadway. In this manner an increased travel resistance may be compensated for by an increased vehicle mass. Such an increased vehicle mass is obtained from the mass of the unloaded vehicle, and a loaded mass and/or a mass appended to the vehicle, such as a trailer attached to the vehicle. The increased travel resistance may also be compensated for by an increased rolling resistance appearing, for example, as a result of unevenness in the roadway, such as stones, roots, potholes or curb stones.

Advantageously, dependent from the brake pedal variable, in the wheel braking devices a braking force is generated which increases from a lower limit toward an upper limit in a manner accustomed to by the driver. Further, the intermediate magnitude of the brake pedal variable is determined as a function of the roadway inclination. The intermediate magnitude as a function of the roadway inclination may be such that the vehicle is held at a standstill on an inclined roadway by the braking force generated in the braking devices at the intermediate magnitude of the brake pedal variable. In this manner a possible rollback of the vehicle at a nominal engine torque value which disappears at the intermediate magnitude is prevented.

Further, in a vehicle which has an automatic transmission, or an automatic gearbox or a transmission with an automatic clutch, the possibility is provided to determine the intermediate magnitude of the brake pedal variable as a function of the roadway inclination. This is effected in such a manner that if the magnitude of the brake pedal variable falls below the intermediate value toward the low limit, the braking force generated in the wheel braking devices, and the actual engine torque obtained based on the nominal engine torque, maintain the vehicle at a standstill on an inclined roadway in the driver-selected direction. Such a standstill is maintained, until the actual engine torque obtained based on the nominal engine torque becomes large enough at a sufficiently small magnitude of the brake pedal variable for setting the vehicle in an uphill motion. In this manner not only a rollback of the vehicle is prevented at a disappearing magnitude of the nominal engine torque at standstill, but also, an uphill starting without rollback of the vehicle is achieved.

The roadway inclination is obtained from a longitudinal roadway inclination which represents an inclination in the length direction of the vehicle, a transverse roadway inclination which represents an inclination in the transverse direction of the vehicle and a yaw angle which represents a yaw angle of the vehicle. The longitudinal inclination of the vehicle may be determined in a simple manner from a difference between a total acceleration or a total deceleration in the length direction of the vehicle and a longitudinal vehicle acceleration or a longitudinal vehicle deceleration obtained from a speed change in the length direction of the vehicle. The total acceleration or total deceleration in the length direction of the vehicle is obtained from the sum of the forces acting on the vehicle in its length direction and may be measured by a longitudinal acceleration sensor. The longitudinal acceleration or longitudinal deceleration of the vehicle may be determined, for example, as a function of a change in time of a wheel rpm variable representing the rpm of at least one of the driven vehicle wheels, while taking into account a steering angle variable which represents a steering angle set at the steerable wheels by a steering wheel. The determination of the transverse roadway inclination may be obtained in a similar manner.

Advantageously, a recognition of an uphill-oriented starting operation or an upward vehicle travel is obtained by an evaluation of a gear shift variable which represents the momentarily set gear or a travel stage variable which represents the automatically set travel stage as well as by an evaluation of the roadway inclination.

The decision whether a roadway is ascending in the travel direction selected by the driver is simply obtained from the gear shift variable or the travel stage variable which supplies information whether the set gear or set travel stage is a forward gear or a reverse gear and is further obtained from the sign of the determined roadway inclination.

Advantageously, the influencing of the actual engine torque is effected in a previously determined travel speed range; the influence of the actual engine torque decreases as the travel speed increases.

Expediently, the actual engine torque is influenced by the roadway inclination and/or the vehicle mass and/or the rolling resistance essentially only below a predetermined limit travel speed. To achieve such a result, when the predetermined limit travel speed is exceeded, the nominal engine torque decreases with increasing travel speed. The limit travel speed may have a magnitude which, in particular, is typical for a transition between a creeping motion and a normal travel. In this manner the auxiliary function is, as needed, active only at low travel speeds which are particularly typical for a creeping travel.

By “creeping event” or “creeping motion” the following is to be meant: If in a vehicle which is on a level roadway and which has, for example, an automatic transmission, a travel stage is being set, the vehicle will travel at a low speed based on the torque delivered by the engine in idling, without the driver having to actuate the gas pedal.

The method and the apparatus according to the invention will be discussed in the ensuing description in conjunction with the drawing, where

FIG. 1 is a schematic illustration of an embodiment of an apparatus according to the invention,

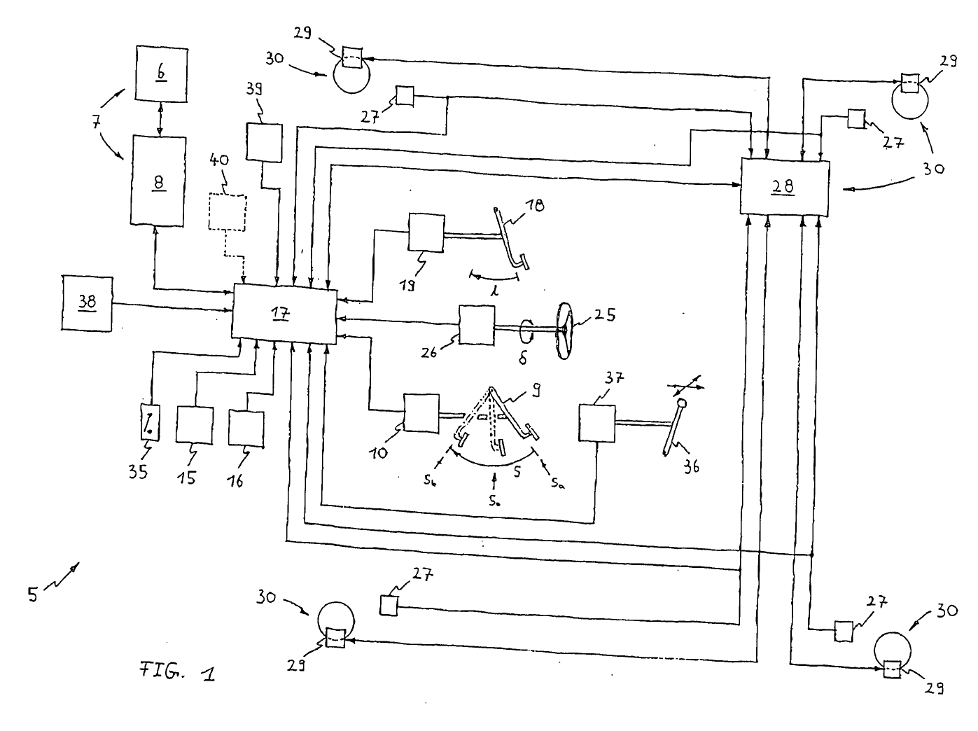

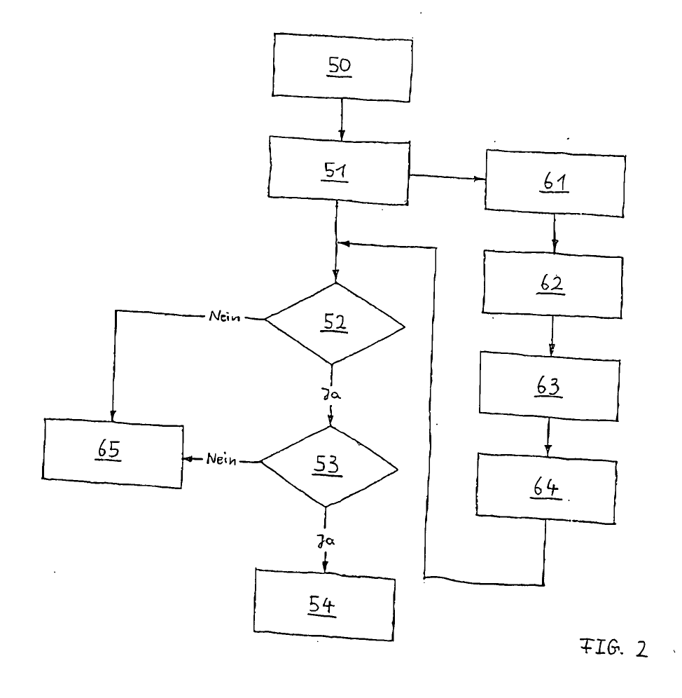

FIG. 2 is a flowchart of an embodiment of the method according to the inventions

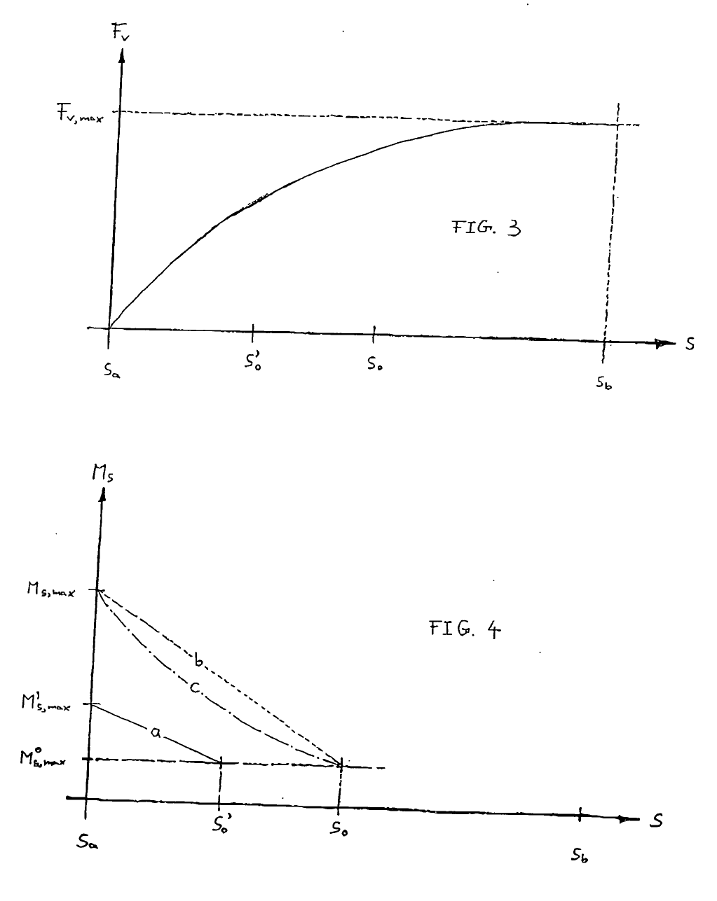

FIG. 3 is a diagram showing, as an example, the braking force as a function of the brake pedal variable and

FIG. 4 is a diagram showing, as an example, the nominal engine torque as a function of the brake pedal variable.

FIG. 1 illustrates an apparatus 5 for influencing an actual engine torque Mᵢ supplied by an engine 6 which forms a part of driving means 7 of a vehicle. The apparatus 5 provides an auxiliary function for the vehicle driver for executing a creeping motion even in case of a travel resistance caused by a driver-selected uphill travel direction.

To this end the apparatus 5 has a brake pedal 9 cooperating with a brake pedal sensor 10 which records a brake pedal variable s representing a deflection of the brake pedal effected by the driver. The brake pedal sensor 10 converts the brake pedal variable into a corresponding deflection signal which is applied to an evaluating unit 17. The latter also receives signals from a longitudinal acceleration sensor 15 provided in the vehicle and measuring the total acceleration or total deceleration of the vehicle in the length direction of the vehicle and signals from a transverse acceleration sensor 16 provided in the vehicle and measuring a total acceleration and total deceleration of the vehicle in the transverse direction of the vehicle. The apparatus 5 further has a gas pedal 18 cooperating with a gas pedal sensor 19 for recording a gas pedal variable 1 which represents a deflection of the gas pedal 18 effected by the driver. The gas pedal sensor 19 converts the gas pedal variable 1 into a corresponding deflection signal which is applied to the evaluating unit 17. Further, a steering wheel 25 is provided which cooperates with a steering wheel sensor 26, registering a steering angle δ representing a steering angle of the non-illustrated steered wheels of the vehicle set by the steering wheel 25. The steering wheel sensor 26 converts the steering angle δ into a corresponding steering angle signal. The latter is applied to the evaluating unit 17 in addition to the signals generated by the wheel rpm sensors 27. In current vehicles which are provided, for example, with an anti-blocking system (ABS) and/or a drive slippage regulator (ASR) and/or an electronic stability program (ESP), the wheel rpm sensors 17 and thus the wheel rpm signals are also present as a rule. The latter may be applied to the evaluating unit 17 over an already installed CAN bus system (Controller Area Network). The evaluating unit 17 is, in turn, connected with a drive means control 8 of the drive means 7 and with a brake means control 28 which is part of the brake means 30 of the vehicle, for controlling, by the drive means control 8, the engine 6 based on the evaluation of signals applied to the evaluating unit 17 and for controlling, by the brake means control 28, the wheel braking devices 29 which are also part of the braking means 30. The wheel braking devices 29 are, for example, concretely designed as wheel brake cylinders. The drive means control 8 and the engine 6 constitute only one part of the drive means 7 of the vehicle; thus, for example, gearing and clutch are not shown for the sake of clarity. Further, the evaluating unit 17 recognizes the gear selected by the driver by operating a gear shift lever 36. For this purpose, the gear shift lever 36 cooperates with a gear recognizing means 37 which registers a gear shift variable x_{g} representing the applied gear and converting it into a corresponding gear shift signal which too, is applied to the evaluating unit 17. As concerns the gear shift lever 36, it may be part of a manual or an automatic transmission. In case of an automatic transmission, the selected travel stage may be effected without evaluating the position of the gear shift lever 36, for example, by an evaluation of the input rpm and the output rpm of the automatic transmission.

The auxiliary function is activated and deactivated by the driver with a switch 35 which is connected to the evaluating unit 17. A selection of the switch is effected by the driver preferably based on a menu panel of a combined menu unit pre-existing in the vehicle.

In the activated state of the auxiliary function the actual engine torque Mᵢ which is delivered by the engine 6 and which drives the vehicle by its driven wheels along a roadway, is determined or influenced in case of an uphill oriented start operation or an uphill drive of the vehicle, as a function of a magnitude Θ* of the roadway inclination which represents a roadway inclination in the travel direction of the vehicle. The roadway inclination Θ* is determined by the evaluating unit 17 based on the signals applied thereto. In addition, the actual engine torque Mᵢ of the engine 6 is determined or influenced as a function of the brake pedal variable s, for which purpose the evaluating unit 17 controls the engine 6 by the drive means control 8 as a function of the brake pedal variables.

The apparatus 5 is used in a vehicle provided with an automatic transmission or an automated gear box or a transmission with an automatic clutch. In such a case the actual engine torque Mᵢ is determined or influenced in such a manner by a corresponding actuation of the drive means control 8 with the intermediary of the evaluating unit 17 for an uphill oriented start or an uphill travel that the vehicle assumes a low travel speed v_{f} which is independent from the roadway inclination and which, in particular, has a magnitude which is typical for a creeping motion.

In a vehicle having an automatic transmission or an automated gearbox or a transmission with an automatic clutch, a low travel speed v_{f} typical for a creeping motion is set merely by shifting a travel stage or the reverse travel stage into first gear or, respectively, into reverse gear. The thus-obtained low travel speed v_{f}typically corresponds to a walking speed in the range of a few kilometers per hour. By means of an appropriate actuation of the brake pedal 9 cooperating with the braking means 30 and the drive means 7, the thus-obtained travel speed v_{f} may be reduced to zero, while with an increasing deflection of the brake pedal 9 a braking force Fᵥ, affecting the wheel braking devices 29 of the vehicle, increases and the actual engine torque Mᵢ simultaneously decreases down to a minimum actual idling engine torque M_{i,0}. The latter has to be maintained to ensure a faultless operation of the engine 6.

In a vehicle which is provided with an automated gearbox or a transmission with an automatic clutch, in order to prevent a possible stalling of the engine 6 in the course of the earlier-described braking process, the clutch in such transmissions is engaged and disengaged in a suitable manner by a clutch means control 38 which cooperates with the evaluating unit 7. The clutch means control 38 is already installed in such vehicles and may be utilized within the framework of the auxiliary function for executing a creeping motion.

According to the method, the influencing of the actual engine torque Mᵢ is effected by the determination of a value of the nominal engine torque Mₛ as a function of the roadway inclination Θ* and the brake pedal variable s by means of the evaluating unit 17. The magnitude of the nominal engine torque Mₛ determined as a function of the roadway inclination Θ* and the brake pedal variable s serve as a previously determined magnitude based on which the evaluating unit 17 influences the actual engine torque Mᵢ by means of the drive means control 8.

The range of the brake pedal variable s is given by a lower limit sₐ and an upper limit s_{b}, whereby a deflection range of the brake pedal 9 is determined, within which the brake pedal 9 may be displaced by the driver. The non-actuated state of the brake pedal is associated with the lower limit sₐ, and the maximum deflection of the brake pedal is associated with the upper limit s_{b}. Upon a deflection of the brake pedal 9, the magnitude of the nominal engine torque Mₛ determined by the evaluating unit 17 decreases from a maximum nominal engine torque M_{s,max} at the lower limit sₐ toward the upper limit s_{b}. For the magnitudes of the brake pedal variable s which equal an intermediate magnitude s₀ in the range given by the lower limit sₐ and the upper limit s_{b}, the nominal engine torque Mₛ assumes a constant, for example, zero magnitude. The intermediate magnitude s₀ of the brake pedal variable s typically amounts to 25 to 35% of the difference between the upper limit s_{b} and the lower limit sₐ.

The maximum magnitude of the nominal engine torque M_{s,max} is determined by the evaluating unit 17 according to the equation
M_{s,max}=M⁰_{s,max}+k.|Θ*|, wherein

M⁰_{s,max} represents the magnitude of the engine torque M_{s,max} which is set by the idling regulator of the engine at an applied travel stage on a roadway with no inclination. Further, k is a factorial function which is stored in the evaluating unit 17. It is selected in such a manner that the vehicle always assumes, for an uphill start operation or an uphill travel, the same low travel speed v_{f} at least at the lower limit sₐ of the brake pedal variable s, independently from roadway inclination. The low travel speed v_{f} has a typical magnitude for a creeping motion of the vehicle.

In addition to influence the magnitude of the nominal engine torque Mₛ as a function of the roadway inclination Θ*, the magnitude of the nominal engine torque Mₛ is influenced as a function of the vehicle mass variable representing the mass of the vehicle for a roadway essentially with no inclination, as well as for an uphill-directed start or an uphill travel. The vehicle mass is composed of the mass of the empty vehicle and a loaded mass and/or a mass appended to the vehicle, such as a trailer. The determination of the vehicle mass is effected either automatically by a mass determining unit 39 cooperating with the evaluating unit 17, for example, in accordance with the apparatus disclosed in DE 38 43 818 C1 or in the alternative, by a manual input from the driver by means of a mass inputting unit 40 connected with the evaluating unit 17. The magnitude of the nominal engine torque Mₛ is increased by the evaluating unit 17 with increasing vehicle mass, starting from a magnitude of the nominal engine torque Mₛ pertaining to the mass of the empty vehicle to compensate for an increased travel resistance because of the increased vehicle mass.

Further, the evaluating unit 17 takes into account a rolling resistance variable characterizing the rolling resistance of the vehicle wheels traveling on the roadway. To this end the evaluating unit 17 evaluates the wheel rpm signals emitted by the wheel rpm sensors 27 and increases the magnitude of the nominal engine torque Mₛ to a corresponding extent in case of a significant decrease of the wheel rpm, for example, because the vehicle wheels hit a curb stone. In this manner it is ensured that the creeping motion is maintained, or at least not stopped.

The braking force Fᵥ generated in the wheel braking devices 29 as a function of the brake pedal variable s increases in the manner to which the driver is accustomed, from the low limit sₐ toward the upper limit s_{b}. At the same time, the intermediate magnitude s₀ of the brake pedal variable s is influenced by the evaluating unit 17 as a function of the roadway inclination Θ*. The influencing of the intermediate magnitude so is effected by the evaluating unit 17 in such a manner that the vehicle is held at a standstill on an inclined roadway solely by the braking force Fᵥ generated at the intermediate magnitude so in the wheel braking devices 29. In this manner a possible rollback of the vehicle is prevented at a disappearing magnitude of the nominal engine torque Mₛ at the intermediate magnitude s₀.

In a vehicle which has an automatic transmission or an automated gearbox or a transmission with an automatic clutch, the intermediate magnitude so of the brake pedal variable s is furthermore set or determined by the evaluating unit 17 as a function of the roadway inclination Θ* as follows: If the brake pedal variable s falls below the intermediate magnitude s₀ toward the lower limit sₐ, the braking force Fᵥ generated in the wheel braking devices 29 and the actual engine torque Mᵢ generated in accordance with the magnitude of the nominal engine torque Mₛ maintain the vehicle at a standstill on an inclined roadway in an uphill travel direction selected by the driver, until the actual engine torque Mᵢ generated in accordance with the nominal engine torque Mₛ becomes, at a sufficiently small magnitude of the brake pedal variable s, large enough for setting the vehicle in an uphill motion.

The roadway inclination Θ* is determined by the evaluating unit 17 from a longitudinal roadway inclination Θ which represents a roadway inclination in the length direction of the vehicle, a transverse roadway inclination Φ which represents a roadway inclination in the transverse direction of the vehicle and a yaw angle β which represents a yaw angle of the vehicle. The determination may be obtained with sufficient accuracy, for example, by the equation
Θ=Θ.cos β+Φ.cos β

which is entered in the evaluating device 17. The yaw angle β is determined sufficiently accurately for the application, for example, from the steering angle δ, in accordance with a single-track vehicle model, while neglecting lateral forces acting on the vehicle.

The longitudinal roadway inclination Θ is determined by the evaluating unit 17 from a difference of a total acceleration or total deceleration which is obtained from the sum of the forces acting on the vehicle in the length direction of the vehicle and which is measured by means of the longitudinal acceleration sensor 15 and a longitudinal vehicle acceleration or longitudinal vehicle deceleration which is obtained from a speed change of the vehicle in the length direction of the vehicle. The longitudinal vehicle acceleration or longitudinal vehicle deceleration is determined as a function of the change in time of a wheel rpm representing the rpm of at least one of the vehicle wheels while taking into account the steering angle δ. The determination of the transverse roadway inclination Φ is effected in a similar manner; instead of the longitudinal acceleration sensor 15 the transverse acceleration sensor 16 finds application.

The recognition of the ascending roadway in the direction selected by the driver, that is, an uphill start operation or an uphill travel is effected by the evaluating unit 17 by evaluating the gear shift variable x_{g} or the travel stage variable x_{g}′ and the roadway inclination Θ*, by utilizing an information which is obtained from the gear shift variable x_{g} or the travel stage variable x_{g}′ and which indicates whether a forward gear or a reverse gear has just been set with the gear shifting lever 36. Further utilized by the evaluating unit 17 is the information concerning the momentary sign of the roadway inclination Θ*.

The actual engine torque Mᵢ is influenced by the evaluating unit 17 as a function of the roadway inclination Θ and/or the vehicle mass essentially only below a previously given limit travel speed v_{fg} entered into the evaluating unit 17. To this end the magnitude of the nominal engine torque Mₛ is reduced with increasing travel speed v_{f} upon exceeding the limit travel speed v_{fg}. The limit travel speed v_{fg} has a typical magnitude for the transition between the creeping motion and the normal vehicle travel. The limit travel speed v_{fg} which thus defines the transition from creeping motion to normal travel, has a typical magnitude in the range of a few kilometers per hour.

If the vehicle has a low travel speed v_{f} which is of a typical magnitude for a creeping motion, then in case of a roadway in a driver-selected descending travel direction, the evaluating unit 17 affects the braking force Fᵥ automatically as a function of the roadway inclination Θ* in such a manner that the vehicle can assume at the most a predetermined maximum travel speed v_{fh} entered into the evaluating unit 17. In this manner the low travel speed v_{f} is prevented from increasing in an uncontrolled manner in case the driver has not actuated or has not sufficiently actuated the brake pedal 9. Upon a deflection of the gas pedal 18 for accelerating the vehicle, the braking force Fᵥ generated in the wheel braking devices 29 is reduced in an appropriate manner by the evaluating unit 17 as a function of the gas pedal variable 1.

FIG. 2 shows, as a flowchart, an embodiment of the method which is provided according to the invention for influencing the actual engine torque Mᵢ delivered by the engine 6 of the vehicle and which is performed by the apparatus according to the invention.

The method is started with an initializing step 50 in which the longitudinal roadway inclination Θ, the transverse roadway inclination Φ, the yaw angle β, the brake pedal variable s, the gear shift variable x_{g} or travel stage variable x_{g}′ and the travel speed v_{f} of the vehicle are determined. The initializing step 50 is followed by a first main step 51 in which the roadway inclination Θ* is determined from the longitudinal roadway inclination Θ, the transverse roadway inclination Φ and the yaw angle β.

The roadway inclination Θ* determined in the first main step 51 is utilized in a first secondary step 61 for determining the intermediate magnitude s₀ of the brake pedal variable s and the maximum magnitude of the nominal engine torque M_{s,max}. The determination of the latter is effected while taking into account the factorial function k.

In a second secondary step 62 a characteristic curve of the nominal engine torque Mₛ is determined which corresponds to the magnitude pair {M_{s,max}, s₀} determined in the initializing step 50. The course of the determined characteristic curve of the nominal engine torque Mₛ is ideally such that a vehicle provided with an automatic transmission or an automated gear box or a transmission with an automatic clutch, assumes, at a given brake pedal variable s which lies within the range defined by the lower limit sₐ and the intermediate value s₀ and which is independent from the roadway inclination Θ*, basically the same low travel speed v_{f} which is typical for the creeping motion of the vehicle. In a third secondary step 63, based on the determined characteristic curve, the magnitude of the nominal engine torque Mᵢ is determined which corresponds to the momentary brake pedal variable s. If the travel speed v_{f} of the vehicle exceeds the previously determined limit travel speed v_{fg}, in a fourth secondary step 64 the nominal engine torque Mᵢ is, as the travel speed v_{f} increases, reduced down to zero, so that in such a case the actual engine torque Mᵢ is no longer influenced. The limit travel speed v_{fg} has a typical magnitude for a transition between a creeping motion and a normal travel.

The roadway inclination Θ* determined in the first main step 51 is utilized in a second main step 52, in which, based on the sign of the roadway inclination Θ* and the gear shift variable x_{g} or the travel stage variable x_{g}′, a roadway is recognized which ascends in the driver-selected travel direction, that is, there is recognized an uphill oriented start operation or an uphill travel.

If a roadway is present which ascends in the travel direction selected by the driver, in a third main step it is verified whether the auxiliary function has been activated. Should this be the case, in a fourth main step 54 the control of the drive means control 7 is initiated corresponding to the nominal engine torque Mₛ determined in the fourth secondary step 64.

If, however, in the second main step 52 it is determined that there is no ascending roadway in the travel direction selected by the driver and/or in the third main step 53 it is determined that the auxiliary function is deactivated, then in a fifth secondary step 65 the nominal engine torque Mₛ is set to zero which means that there will be no influence on the actual engine torque Mᵢ.

FIG. 3 illustrates a diagram which shows exemplarily the braking force Fᵥ as a function of the brake pedal variable s. As the driver increases the brake pedal variable s in the customary manner, that is, as the deflection of the brake pedal 9 increases, the braking force Fᵥ increases toward the upper limit s_{b}, starting from the lower limit sₐ in which the braking force Fᵥ is zero.

FIG. 4 illustrates a diagram which shows exemplarily the nominal engine torque Mₛ as a function of the brake pedal variable s. As seen, there is basically a decrease of the nominal engine torque Mₛ from the lower limit sₐ toward the upper limit s_{b}.

Not considering first the influence of the vehicle mass and the rolling resistance for the sake of simplicity, each of the three illustrated curves a, b and c corresponds to a certain roadway inclination Θ*. The curve a shown as a solid line represents a roadway of essentially no inclination or a descending roadway selected by the driver in the travel direction. In case of an ascending roadway in the driver-selected travel direction, the maximum nominal engine torque M_{s,max} and the intermediate magnitude so are increased with an increasing roadway inclination Θ* increases, whereby a broken-line curve b is obtained which lies above the solid-line curve a.

In case of an ascending roadway inclination in a travel direction selected by the driver, the maximum magnitude of the nominal engine torque M_{s,max} is determined by the equation M_{s,max}=M⁰_{s,max}+k.|Θ*|, so that with increasing magnitudes in the roadway inclination Θ*, the magnitude of the maximum nominal engine torque M_{s,max} increases starting from the magnitude M⁰_{s,max}.

The determination of the intermediate magnitude s₀ of the brake pedal variable s is effected in one of two ways: First, the determination is such that the braking force Fᵥ generated in the wheel braking devices 29 in FIG. 3 is just sufficiently large to hold the vehicle on an inclined roadway securely at standstill. Or, second, in case the brake pedal variable s falls below the intermediate magnitude so toward the lower limit sₐ, the determination is such that the braking force Fᵥ in FIG. 3 generated in the wheel braking devices 29 and the actual engine torque Mᵢ, produced in accordance with the magnitude of the nominal engine torque Mₛ, hold the vehicle on an inclined roadway in the travel direction selected by the driver. Such a holding continues until the actual engine torque Mᵢ, obtained corresponding to the magnitude of the nominal engine torque Mₛ, attains a large enough magnitude at a sufficiently small magnitude of the brake pedal variable s for setting the vehicle in uphill motion. In this manner an intermediate magnitude s₀ is obtained which increases with the magnitude of the roadway inclination Θ*.

The curves need not be straight lines; rather, other arbitrary curve courses are also feasible, shown symbolically by a dash-dot curve c, which lead to a low travel speed v_{f} independently from the roadway inclination Θ*.

1. A method of influencing an actual engine torque delivered by an engine (6) which is part of drive means (7) of a vehicle, wherein the actual engine torque (Mᵢ), at an uphill oriented starting operation or at an uphill travel, is determined as a function of a determined roadway inclination (Θ*) which represents a roadway inclination in the travel direction,
characterized in that
a brake pedal variable (s) is determined which represents a driver-caused deflection of a brake pedal (9) cooperating with braking means (30) of the vehicle, and the actual engine torque (Mᵢ) delivered by the engine (6) is further determined as a function of the determined brake pedal variable (s).

2. The method as defined in claim 1,
characterized in that
the actual engine torque (Mᵢ) is determined in such a manner as a function of the roadway inclination (Θ*) that the vehicle assumes, independently from the roadway inclination, a low travel speed (v_{f}) which, in particular, has a typical magnitude for a creeping motion of a vehicle provided with an automatic transmission or an automatic gearbox or a transmission with an automatic clutch.

3. The method as defined in claim 1,
characterized in that
a magnitude for a nominal engine torque (Mₛ) is determined as a function of the roadway inclination (Θ*) and the brake pedal variable (s) and that the actual engine torque (Mᵢ) is set in accordance with the determined magnitude of the nominal engine torque (Mₛ).

4. The method as defined in claim 3,
characterized in that
the brake pedal variable (s) has a range defined by a lower limit (sₐ) corresponding to the non-actuated state of the brake pedal (9) and an upper limit (s_{b}) corresponding to a maximum possible deflection of the brake pedal (9), wherein the magnitude of the nominal engine torque (Mₛ) decreases from a maximum magnitude (M_{s,max}) at the lower limit (sₐ) toward the upper limit (s_{b}).

5. The method as defined in claim 4,
characterized in that
for magnitudes of the brake pedal variable (s) which correspond to an intermediate magnitude (s₀) lying in the range between the lower limit (sₐ) and the upper limit (s_{b}), the nominal engine torque (Mₛ) assumes a constant, particularly zero, magnitude.

6. The method as defined in claim 4,
characterized in that
the maximum nominal engine torque (M_{s,max}) as a function of the roadway inclination (Θ*) is determined by the equation M_{s,max}=M⁰_{s,max}+k.|Θ*|, wherein k is a factorial function and M⁰_{s,max} is the engine torque (Mₛ) obtained by the idling regulator of the engine at a set travel stage on a roadway without inclination.

7. The method as defined in claim 6,
characterized in that
the factorial function (k) is selected in such a manner that at least in the lower limit (sₐ) of the brake pedal variable (s) the vehicle assumes, independently from the roadway inclination, a low travel speed (v_{f}) which is particularly typical for a creeping motion of a vehicle having an automatic transmission, or an automatic gearbox or a transmission with an automatic clutch.

8. The method as defined in claim 3,
characterized in that
the nominal engine torque (Mₛ) is additionally determined as a function of a vehicle mass variable representing the mass of the vehicle and/or as a function of a rolling resistance variable characterizing the rolling resistance of the driven wheels traveling on the roadway.

9. The method as defined in claim 4,
characterized in that
as a function of the brake pedal variable (s), in the wheel braking devices (29) of the vehicle a braking force (Fᵥ) is generated which increases from the lower limit (sₐ) toward the upper limit (s_{b}).

10. The method as defined in claim 5,
characterized in that
the intermediate magnitude (s₀) of the brake pedal variable (s) is determined as a function of the roadway inclination (Θ*).

11. The method as defined in claim 5,
characterized in that
the intermediate magnitude (s₀) is determined as a function of the roadway inclination (Θ*) in such a manner that the vehicle is maintained at a standstill on an inclined roadway by the braking force (Fᵥ) generated in the wheel braking devices (29) at the intermediate magnitude (s₀).

12. The method as defined in claim 11,
characterized in that
the intermediate magnitude (s₀) is determined as a function of the roadway inclination (Θ*) in such a manner that when the magnitude of the brake pedal variable (s) falls below the intermediate magnitude (s₀) toward the lower limit (sₐ), the braking force (Fᵥ) generated in the wheel braking devices (29) and the actual engine torque (Mᵢ) effected by the nominal engine torque (Mₛ) maintain the vehicle at a standstill on an inclined roadway oriented in a driver-selected direction, until the actual engine torque (Mᵢ) effected correspondingly to the nominal engine torque (Mₛ) becomes large enough at a sufficiently small magnitude of the brake pedal variable (s) for setting the vehicle in uphill motion on the inclined roadway.

13. The method as defined in claim 1,
characterized in that
the roadway inclination (Θ*) is determined from a longitudinal roadway inclination (Θ) which represents a roadway inclination in the length direction of the vehicle, a transverse roadway inclination (Φ) which represents a roadway inclination in the transverse direction of the vehicle and a yaw angle (β) which represents a yaw angle of the vehicle.

14. The method as defined in claim 13,
characterized in that
the longitudinal roadway inclination (Θ) is determined from a difference between a total acceleration or a total deceleration in the length direction of the vehicle and a longitudinal vehicle acceleration or a longitudinal vehicle deceleration, obtained from a speed change in the length direction of the vehicle and/or the transverse roadway inclination (Φ) is determined from a difference between a total acceleration or a total deceleration in the transverse direction of the vehicle, obtained from a speed change in the transverse direction of the vehicle.

15. The method as defined in claim 14,
characterized in that
the longitudinal vehicle acceleration or the longitudinal vehicle deceleration and/or the transverse vehicle acceleration or the transverse vehicle deceleration are determined as a function of the change in time of a wheel rpm variable representing the wheel rpm of at least one of the driven vehicle wheels, while a steering angle (δ) is taken into account which represents a steering angle set by a steering wheel (25) at the steerable vehicle wheels.

16. The method as defined in claim 1,
characterized in that
a recognition of the uphill-directed start operation or uphill travel is effected by an evaluation of a gear shift variable (x_{g}) which represents the gear set by the driver or a travel stage variable (x_{g}′) which represents the automatically set travel stage and by an evaluation of the roadway inclination (Θ*).

17. The method as defined in claim 3,
characterized in that
the influencing of the actual engine torque (Mᵢ) is effected in a previously determined travel speed range, and the influencing of the actual engine torque (Mᵢ) decreases with increasing travel speed (v_{f}).

18. An apparatus for influencing an actual engine torque delivered by an engine (6) which forms part of drive means (7) of a vehicle, wherein the apparatus comprises means (15, 16, 17, 25, 26, 27) with which a roadway inclination (Θ*) representing a roadway inclination in the travel direction is determined and further comprises means (8, 17) with which the actual engine torque (Mᵢ) is determined during an uphill-directed start operation or an uphill travel as a function of the determined roadway inclination (Θ*),
characterized in that
means (9, 10, 17) are provided with which a brake pedal variable (s) is determined which represents a driver-caused deflection of a brake pedal (9) cooperating with braking means (29) of the vehicle and that the actual engine torque (Mᵢ) delivered by the engine (6) is further determined as a function of the determined brake pedal variable (s).
